(19) United States
(12) Patent Application Publication
(10) Pub. No.: US 2002/0057941 A1
(43) Pub. Date: May 16, 2002

(54) Connection structure between a pipe and a tube for use in a heat exchanger

(76) Inventors: Ichio Nakajima, Isesaki-shi (JP); Tsuneo Kousaka, Isesaki-shi (JP); Takeo Masuda, Isesaki-shi (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/984,162

(22) Filed: Oct. 29, 2001

Related U.S. Application Data
(63) Continuation-in-part of application No. 09/594,574, filed on Jun. 15, 2000.
(63) Continuation-in-part of application No. 09/594,512, filed on Jun. 16, 2000.

(30) Foreign Application Priority Data
Jun. 15, 1999 (JP) 11-169037
Jun. 17, 1999 (JP) 11-171727

(51) Int. Cl. B25G 3/00; F16B 7/08; F16B 9/00; F16L 41/00

(52) U.S. Cl. 403/230; 285/1

(57) ABSTRACT

An insertion portion of a tube is inserted into a pipe through a tube-insertion aperture formed in the pipe, and the tube-insertion portion is secured to an inner surface of the pipe. The tube may be formed by coupling a pair of tube-forming members. The tube may be provided with a tube-insertion regulating portion at a side of a longitudinal end portion of the tube for regulating a tube-insertion-length relative to the pipe. The coupled pair of tube-forming members are brazed to each other, and that the tube-insertion portion is brazed to the pipe.

### CROSS-REFERENCE TO RELATED APPLICATIONS

This application is a Continuation-in-Part of prior application Ser. No. 09/594,574 filed on Jun. 15, 2000 and Ser. No. 09/594,512 filed on Jun. 16, 2000.

### BACKGROUND OF THE INVENTION

1. Field of the Invention

The present invention relates to a connection structure between a pipe and a tube for use in a heat exchanger including a radiator, a heater core, a condenser and an evaporator for an automobile, and more particularly to, a connection structure between a pipe and a tube preferably for use in a condenser using a high-pressure refrigerant.

2. Description of Related Art

As one of heat exchangers, the so-called parallel flow type heat exchanger is known. As shown in FIG. 23, the parallel flow type heat exchanger includes a pair of pipes A and B, a plurality of flat tubes C disposed between the pipes and a plurality of corrugated fins D each interposed between the adjacent tubes C. In the aforementioned heat exchanger, a high-pressure refrigerant (generally several tens Kg) passes through the heat exchanger to be forcibly rejected heat, resulting in a low-temperature and high-pressure liquefied refrigerant. The heat generated during the liquefaction of the refrigerant is transmitted from the tube C to the corrugated fin D, and then radiated by the wind sent to the corrugated fin D.

The two pipes A and B as shown in FIG. 24 are the same in structure, and the inside space of each pipe is divided by the partition plates E₁, E₂ and E₃ as shown in FIGS. 24 and 26. In this heat exchanger, as shown in FIG. 24, the refrigerant fed from the upper end of the left-side pipe A is introduced into the first groups of tubes C located above the uppermost partition E₁ disposed in the pipe A to reach the other (right side) pipe B through these tubes C. The refrigerant fed in the pipe B is then introduced into the second groups of tubes C located below the above-mentioned first groups of tubes C and located above the partition plate E₂, to reach the left side pipe A. The refrigerant is then introduced into the third groups of tubes C located below the above-mentioned second groups of tubes C and located above the partition plate E₃. Similarly, the refrigerant flows through the tubes C from the right side pipe B to the left side pipe A, and then from the left side pipe A to the right side pipe B. In this case, although the refrigerant is in a gaseous state at the upstream side (upper side), it liquefies as it advances toward the downstream side (lower side), causing an increased flow resistance of the refrigerant. Therefore, in general, the number of tubes C divided by the partition plates E₁, E₂ and E₃ is gradually decreased toward the lower side so that the liquefied refrigerant can easily flow through the lower tubes C.

As to the aforementioned pipes A and B, there are a seamless round pipe, a pipe made by coupling two pipe-forming members F and G as shown in FIG. 25, and a pipe made by rolling a single plate having tube-insertion apertures into a round shape in cross-section. The tubes C are inserted into the tube-insertion apertures H (see FIG. 25) formed in the pipes A and B.

The partition plates E₁, E₂ and E₃ are inserted into the partition-insertion slits J (see FIG. 25) formed in the pipes A and B, thereby dividing the pipes A and B in the axial direction. Each tube C and pipes A and B, as well as each of the partition plates E₁, E₂, E₃ and the pipe A or B, are brazed in a fluid-tight manner at the brazing portions K(shown in black in FIG. 26). At one longitudinal end of the pipe A or B, a cap K is attached as shown in FIG. 23. At the other longitudinal end thereof, a coupling L is attached. The cap K and the coupling L are brazed to the pipes A and B.

The aforementioned conventional pipe for use in a heat exchanger had the following drawbacks.

1. Since the refrigerant flowing through the pipe A and B has a high pressure of several tens Kg, if the brazing portion lacks in strength, cracks can generate at the brazing portion when in use, which in turn causes a gap through which a refrigerant leaks.

2. It is anticipated that the pressure of refrigerant passing through the pipe will be further increased. In this case, even if the brazing portion has enough strength to handle the conventional regular pressure, the brazing portion may not be enough to withstand such an increased high-pressure.

### SUMMARY OF THE INVENTION

It is an object of the present invention to provide a connection structure between a pipe and a tube for use in a heat exchanger having a brazing portion therebetween, wherein the brazing portion can withstand pressure higher than conventional pressure.

According to the present invention, a connection structure between a pipe and a tube for use in a heat exchanger includes a pipe having a tube-insertion aperture, and a tube having an insertion portion, wherein the tube is inserted into the pipe through the tube-insertion aperture, and wherein the insertion portion is secured to an inner surface of the pipe.

In the connection structure, the pipe may be formed by coupling a pair of pipe-forming members or rolling a single plate into a round shape in cross-section. Alternatively, the pipe may be a seamless pipe.

It is preferable that the insertion portion is secured to an inner surface of at least one of the pipe-forming members and the pipe-forming members are secured to each other in a fluid-tight manner.

It is preferable that one of the pipe-forming members is provided with an abutting portion and the other of the pipe-forming members is provided with a receiving portion, and the pipe-forming members are coupled to each other such that the abutting portion abuts against the receiving portion.

It is preferable that one of the pipe-forming members is provided with a fitting groove, and the other of the pipe-forming members is provided with a fitting portion, wherein the fitting portion is secured to the fitting groove in a fluid-tight manner with the fitting portion fitted in the fitting groove.

It is preferable that the pipe-forming members are brazed to each other and the pipe and the tube-insertion portion of the tube are brazed to each other.

It is preferable that the tube is provided with a tube-insertion regulating portion at a side of a longitudinal end portion of the tube for regulating a tube-insertion-length relative to the pipe.

Other objects and the features will be apparent from the following detailed description of the invention with reference to the attached drawings.

### BRIEF DESCRIPTION OF THE DRAWINGS

The present invention will be more fully described and better understood from the following description, taken with the appended drawings, in which:

FIG. 1A is a cross-sectional view of a pipe for use in a heat exchanger in a connection structure between the pipe and a tube for use in the heat exchanger according to a first embodiment of the present invention;

FIG. 1B is an exploded explanatory view of the pipe;

FIG. 1C is an explanatory cross-sectional view of a connection structure of a pipe and a tube for use in a heat exchanger according to the first embodiment;

FIG. 2 is an explanatory cross-sectional view of a connection structure of a pipe and a tube for use in a heat exchanger according to a second embodiment of the present invention;

FIG. 3 is an explanatory cross-sectional view of a connection structure of a pipe and a tube for use in a heat exchanger according to a third embodiment of the present invention;

FIG. 4 is an explanatory cross-sectional view of a connection structure of a pipe and a tube for use in a heat exchanger according to a fourth embodiment of the present invention;

FIG. 5 is an explanatory cross-sectional view of a connection structure of a pipe and a tube for use in a heat exchanger according to a fifth embodiment of the present invention;

FIG. 6 is an explanatory cross-sectional view of a connection structure of a pipe and a tube for use in a heat exchanger according to a sixth embodiment of the present invention;

FIG. 7 is an explanatory cross-sectional view of a connection structure of a pipe and a tube for use in a heat exchanger according to a seventh embodiment of the present invention;

FIG. 8A is a cross-sectional view of a pipe for use in a heat exchanger in a connection structure between the pipe and a tube according to an eighth embodiment of the present invention;

FIG. 8B is an explanatory cross-sectional view of the connection structure;

FIG. 8C is an explanatory exploded view of another embodiment of a pipe for use in a heat exchanger;

FIG. 9A is a cross-sectional view of a pipe for use in a heat exchanger in a connection structure between the pipe and a tube according to a ninth embodiment of the present invention;

FIG. 9B is an explanatory cross-sectional view of a connection structure of the pipe and a tube for use in a heat exchanger according to the ninth embodiment;

FIG. 10 is an explanatory cross-sectional view of a connection structure of a pipe and a tube for use in a heat exchanger according to a tenth embodiment of the present invention;

FIG. 11 is an explanatory cross-sectional view of an eleventh embodiment according to the present invention;

FIG. 12 is a partial plan view of an end portion of a tube according to one embodiment of the present invention;

FIG. 13 shows modifications of tubes, wherein

FIG. 13A is an exploded perspective view of a pair of pipes and a tube, wherein

FIG. 13B is a perspective view of a modified tube, and wherein

FIG. 13C is a perspective view of another modified tube;

FIG. 14A is an enlarged perspective view of an end portion of a modified tube according to the present invention;

FIG. 14B is a perspective view of a further modified tube according to the present invention;

FIG. 15 shows an assembling step of a pipe for use in a heat exchanger according to the present invention;

FIG. 16 shows a plan view of one example of a partition plate;

FIG. 17 is a partially broken explanatory perspective view of one example of a pipe for use in a heat exchanger according to the present invention;

FIG. 18 is a partially broken explanatory perspective view of another example of a pipe for use in a heat exchanger according to the present invention;

FIG. 19A is a cross-sectional view of a tube-insertion aperture formed in a pipe for use in a heat exchanger according to the present invention;

FIG. 19B is a cross-sectional view of a modified tube-insertion aperture formed in a pipe for use in a heat exchanger according to the present invention;

FIG. 19C is a cross-sectional view of a further modified tube-insertion aperture formed in a pipe for use in a heat exchanger according to the present invention;

FIG. 19D is a cross-sectional view of a still further modified tube-insertion aperture formed in a pipe for use in a heat exchanger according to the present invention;

FIG. 20A is a vertical cross-sectional view showing an end of a tube inserted into a tube-insertion aperture of a pipe according to the present invention;

FIG. 20B is a vertical cross-sectional view showing an end of a modified tube inserted into a tube-insertion aperture of a pipe according to the present invention;

FIG. 21 is a vertical cross-sectional view showing ends of tubes each inserted into a tube-insertion aperture formed in a pipe according to an embodiment of the present invention;

FIG. 22 is a vertical cross-sectional view showing ends of tubes inserted into a tube-insertion aperture formed in a pipe according to a modified embodiment of the present invention;

FIG. 23 is an exploded perspective view of a conventional parallel flow type heat exchanger;

FIG. 24 is an explanatory view showing a refrigerant flow in the parallel flow type heat exchanger;

FIG. 25 is an explanatory exploded perspective view of one embodiment of a pipe for use in a conventional parallel flow type heat exchanger previously developed by the present inventors; and

FIG. 26 is a vertical cross-sectional view of one embodiment of a conventional parallel flow type heat exchanger previously developed by the present inventors.

### DETAILED DESCRIPTION OF THE PREFERRED EMBODIMENTS

(First Embodiment)

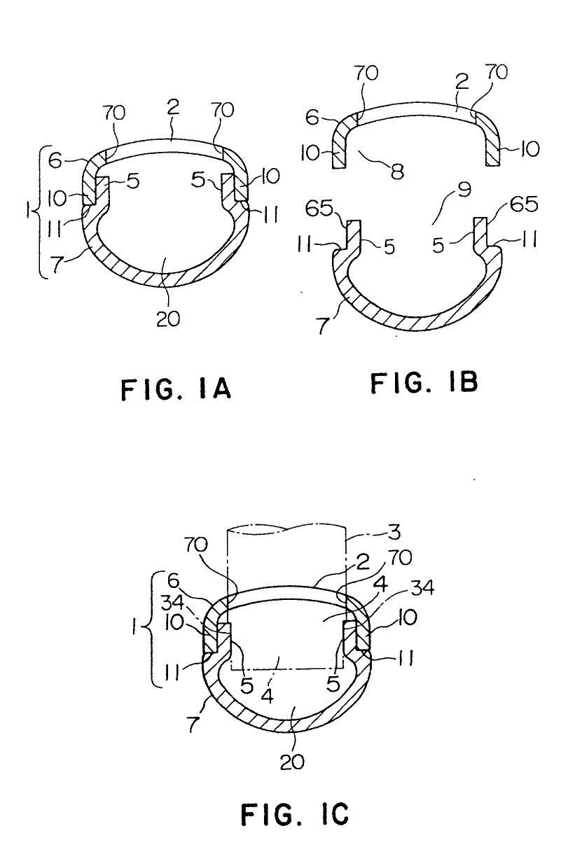

FIGS. 1A to 1C show an example of a connection structure between a pipe and a tube for use in a heat exchanger according to the present invention. In this embodiment, a pair of pipe-forming members 6 and 7 are coupled each other with their opening portion 8 and 9 facing each other to form a pipe 1, thereby forming a refrigerant passage 20 in the pipe 1.

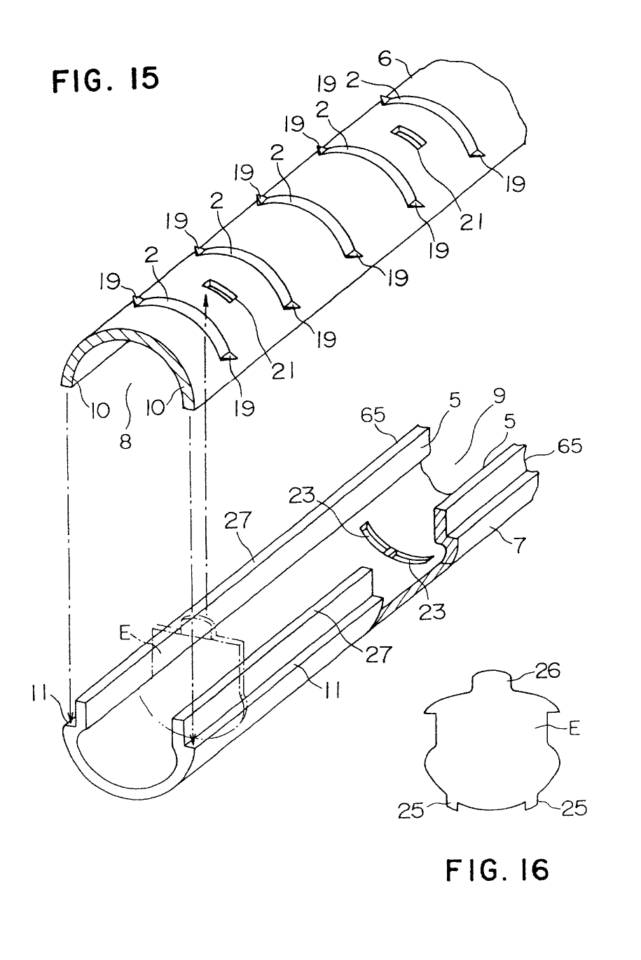

One of the pipe-forming members 6 shown in FIGS. 1A to 1C has a slightly flattened half circular cross-sectional shape. As shown in FIG. 15, the pipe-forming member 6 is provided with a plurality of tube-insertion apertures 2 at certain intervals in the axial direction, and is also provided with partition-insertion apertures 21 between predetermined adjacent tube-insertion apertures 2. Each longitudinal edge of the pipe-forming member 6 forms an abutting portion 10.

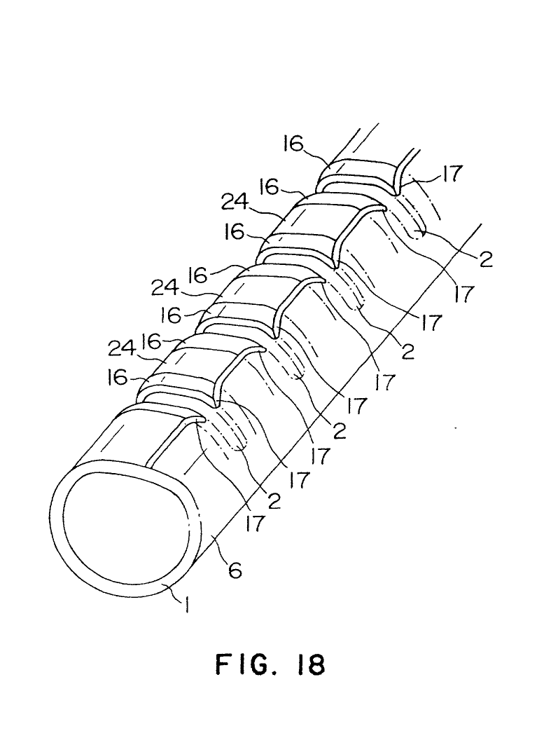

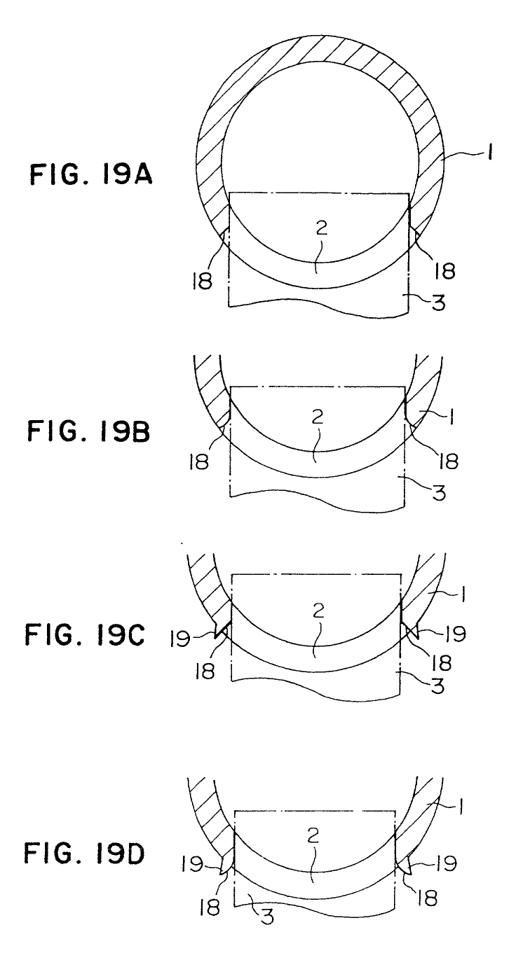

As shown in FIGS. 17 and 18, the longitudinal edges of the tube-insertion aperture 2 are inwardly bent to form inwardly bent portions 17. As shown in FIGS. 19A and 19B, the lateral edges of the tube-insertion aperture 2 are formed to have outwardly curved guide portions 18. The guide portion 18 shown in FIG. 19A has an outwardly opened linear portion extending from the middle of thickness of the pipe 1. On the other hand, the guide portion 18 shown in FIG. 19B has an outwardly curved portion extending from the middle of thickness of the pipe 1. The tube-insertion apertures 2 shown in FIGS. 19C and 19D have outwardly protruded portions 19 formed outside the guide portions 18. The outwardly protruded portion 19 protrudes outwardly from the outer surface of the pipe as shown in FIGS. 15, 19C and 19D. The guide portion 18 and the outwardly protruded portion 19 shown in FIG. 19C extend linearly. The guide portion 18 and the outwardly protruded portion 19 shown in FIG. 19D are outwardly and arcuatedly curved in a continuous manner.

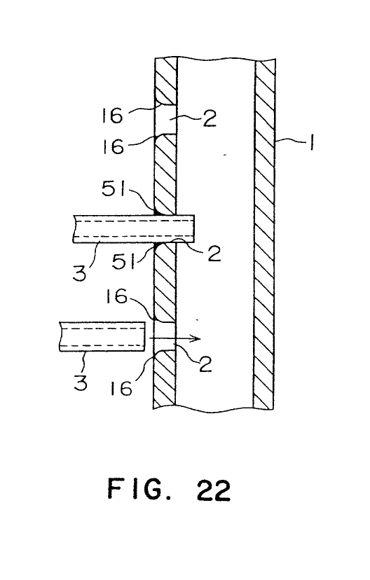

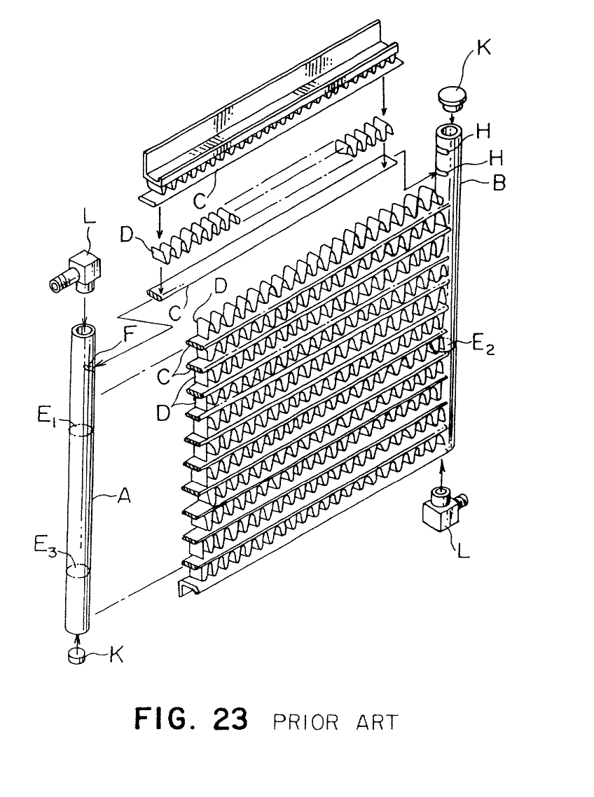

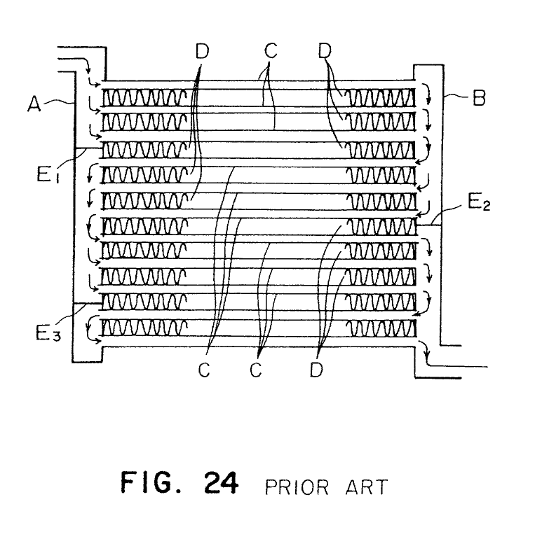

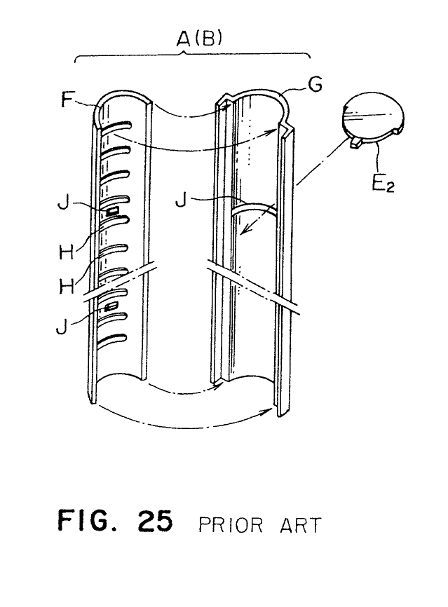

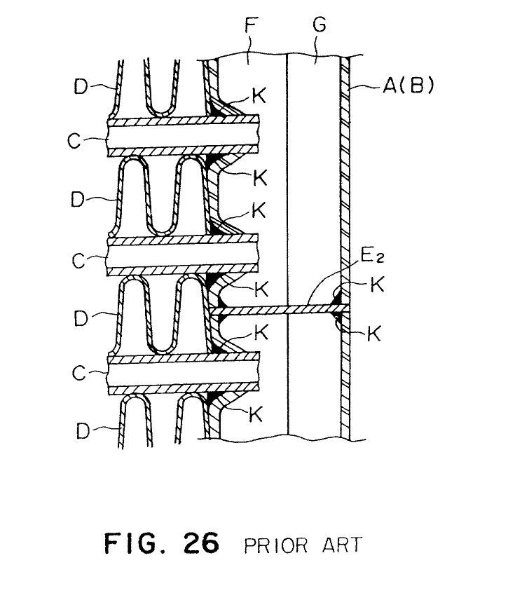

The pipe 1 for use in a heat exchanger shown in FIG. 17 or 18 may be a seamless pipe or a pipe formed by rolling a plate to a round pipe. The outer surface 40 of the pipe 1 shown in FIG. 17 has the same outer surface as in a true circular pipe. The outer surface 24 of the pipe 1 shown in FIG. 18 between the adjacent tube-insertion apertures 2 is formed to have a slightly flat shape. However, the configuration of the outer surface of the tube 1 is not limited to the above. For example, the outer surface between the adjacent tube-insertion apertures 2 may be an outwardly protruded dome shape or the like. Furthermore, the configuration and/or the structure of the tube-insertion aperture 2 are not limited to the above. For example, the longitudinal outer edge 16 of the tube-insertion aperture 2 may not be inwardly bent, and the inwardly bent portion 17 may not be formed. The longitudinal outer edges 16 may be outwardly curved as shown in FIG. 22, or outwardly linearly declined (not shown).

The other pipe-forming member 7 shown in FIGS. 1A to 1C has a generally half-circular shape, and is provided with laterally arranged two partition-insertion slits 23 and 23 at a certain position corresponding to a position between the adjacent tube-insertion apertures 2 and 2 shown in FIG. 15 (i.e., at a position corresponding to the partition-insertion slit 21). The pipe-forming member 7 has a pair of inwardly bent L-shaped receiving portions 11 and 11 at the longitudinal edges, so that the receiving portions 11 and 11 can receive the abutting portions 10 and 10 of the corresponding pipe-forming member 6.

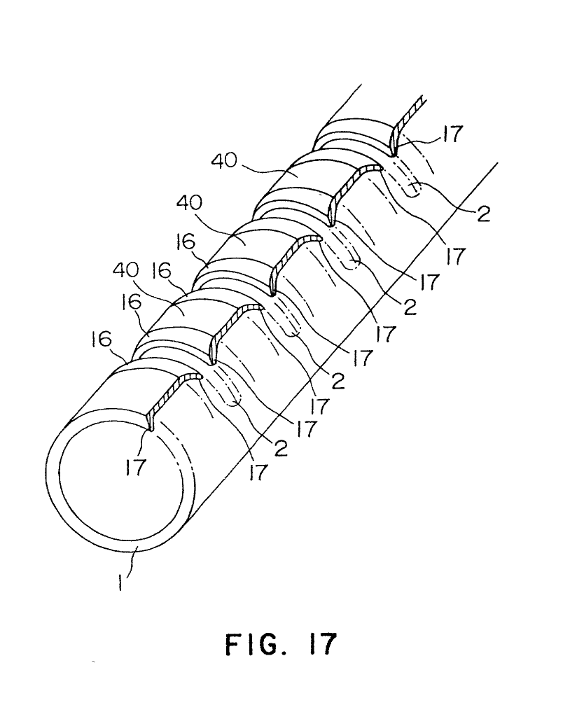

The aforementioned pipe-forming members 6 and 7, the partition plates E (see FIG. 16) and the tubes 3 may be made of any desired materials. However, they are preferably made of, for example, the so-called clad materials comprising an aluminum plate and a thin brazing layers formed on both sides or one side of the aluminum plate.

There are various methods for assembling the two pipe-forming members 6 and 7 into a pipe. One example of the assembling method will be explained as follows. As shown by the phantom line in FIG. 15, the partition plate E shown in FIG. 16 is disposed inside the pipe-forming member 7 such that two insertion protrusions 25 and 25 of the partition plate E are inserted into the partition-insertion slits 23 and 23, and then the other pipe-forming member 6 is disposed thereon. At this time, another insertion protrusion 26 of the partition plate E is inserted into the partition-insertion slit 21 formed in the pipe-forming member 6. The abutting portions 10 of the pipe-member 6 are disposed outside the longitudinal edges of the pipe-forming member 7 with the abutting portions 10 and 10 abutted against the receiving portions 11 to form a pipe 1 for use in a heat exchanger as shown in FIG. 1A.

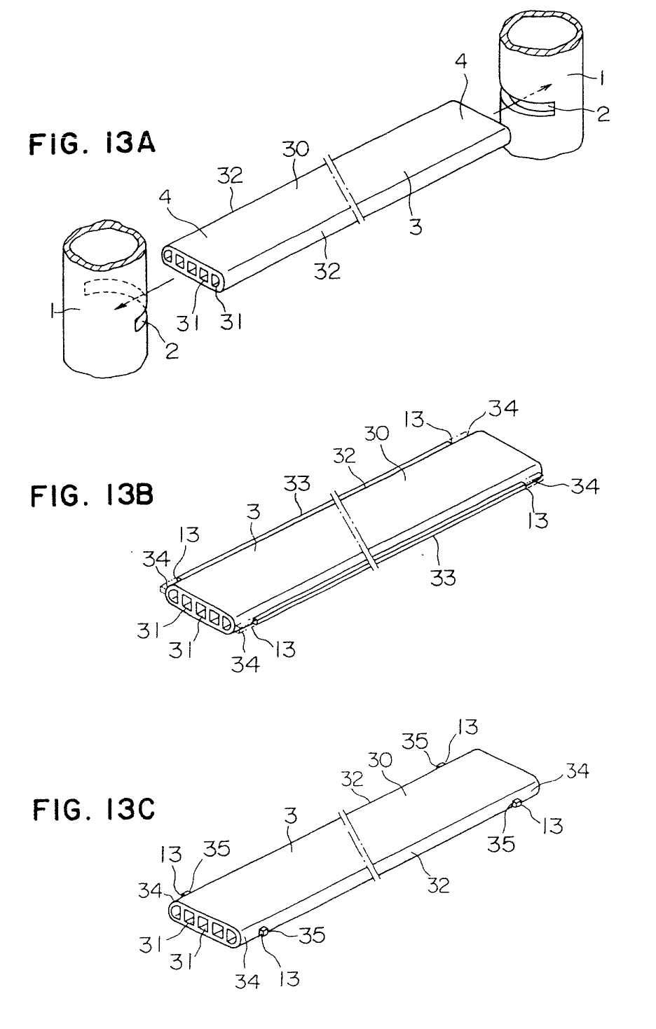

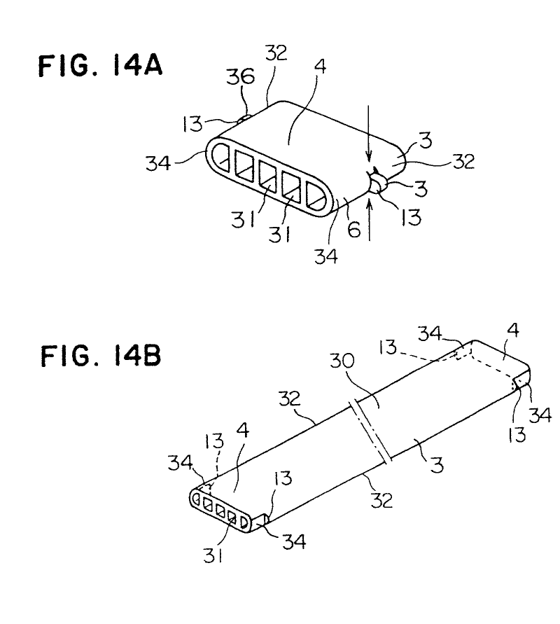

Into the tube-insertion aperture 2 of one of the two pipe-forming members 6 and 7 assembled as shown in FIG. 1A, a tube 3 is inserted as shown in FIG. 1C. As the tube 3, various tubes that are different in configuration and structure may be used. Examples of tubes 3 are shown in FIGS. 13A-13C and FIGS. 14A-14B. These tubes have a plurality of laterally arranged refrigerant passages 31 in the flat-shaped tube main body 30. FIG. 13A shows a basic tube in which the lateral outer surfaces 32 of the main body 30 have a rounded shape. The tube 3 shown in FIG. 13B is provided with outwardly protruded longitudinal edges 33 at the lateral outer surfaces 30 of the tube main body 30. The longitudinal end portions of the outwardly protruded longitudinal edge 33 are cut out to form tube-insertion regulating portions 13. The cut-out portion constitutes a tube-insertion guide portion 34. The tube 3 shown in FIG. 13C is provided with a pair of small protrusions 35 at the lateral sides of the longitudinal end portion of the tube main body 30. The tube-end-side of the small protrusions 35 constitutes a tube-insertion regulating portion 13, and the lateral sides of the end portion of the tube main body 30 between the longitudinal end of the tube body 3 and the small protrusions 35 constitute tube-insertion guide portions 34.

In the tube 3 shown in FIG. 14A, the small protrusion 36 is formed by pressing a part of the lateral side of the end portion of the tube main body 30. The tube-end-side of the small protrusion 36 constitutes a tube-insertion regulating portion 13, and the lateral sides of the end portion of the tube main body 30 between the longitudinal end of the tube main body 30 and the small protrusions 36 constitute tube-insertion guide portions 34.

In the tube 3 shown in FIG. 14B, the tube-insertion guide portion 34 is formed by cutting out or pressing the lateral side of the longitudinal end portion of the tube main body 30, and the shoulder portion 13 of the tube-insertion guide portion 34 constitute a tube-insertion regulating portion 13.

The configuration and/or the structure of the tube 3 are not limited to the above. For example, the tube 3 shown in FIG. 12 may be used. In the tube 3, the lateral sides of the end portion of the tube main body 30 are pressed to form a tapered tube-insertion guide portion 34, and the basal end of the tube-insertion guide portion 34 constitutes a tube-insertion regulating portion 13.

The aforementioned tube-insertion regulating portion 13 formed on the tube 3 regulates the tube-insertion amount of the tube 3 in the tube-insertion aperture 2 by abutting the tube-insertion regulating portions 13 against the outer periphery of the tube-insertion aperture 2, resulting in the same insertion amount of plural tubes 3.

The pipe-forming members 6 and 7 are coupled each other such that the partition plates E are disposed therebetween as shown in FIG. 15. The tubes 3 are inserted into the corresponding tube-insertion apertures 2 formed in the pipe-forming member 6, and corrugated fins (not shown) are disposed between the adjacent tubes 3. Then, the assembled members are placed in a furnace. As a result, the brazing materials on the surface of each member melt to braze the pipe-forming members 6 and 7. At the same time, the tube-insertion guide portion 34 of the tube 3 is secured to the inner surface 5 of the pipe-forming member 7, and the partition plates E and the fins are assuredly brazed to the pipe-forming members 6 and 7 and the tubes 3, respectively.

In the case where the pipe 1 having inwardly bent portions 17 each formed at the inner periphery of the tube-insertion aperture 2 is used as shown in FIGS. 17 and 18, a dented portion (brazing material gathering portion) is formed between the peripheral outside edge 16 of the tube-insertion aperture 2 including the inwardly bent portion 17 and the tube 3 inserted into the tube-insertion aperture 2, resulting in an introduction of the melted brazing materials into the dented portion, which results in an assured and strong brazing.

In cases where the pipe 1 is provided with outwardly opening guide portions 18 at the lateral ends of the tube-insertion aperture 2 as shown in FIGS. 19A and 19B, a dented portion (brazing material gathering portion) is formed between the guide portion 18 and the tube 3 inserted in the tube-insertion aperture 2. In cases where the pipe 1 is provided with outwardly protruded portions 19 formed outside the guide portion 18 of the tube-insertion aperture 2, a dented portion is formed between the guide portion 18 including the protruded portion 19 and the tube 3 inserted in the tube-insertion aperture 2. As a result, the melted brazing materials are gathered in the dented portion, causing a fluid-tight brazing between both side surfaces 70 of the tube-insertion aperture 2 and the outer surface of the tube 3 inserted into the tube-insertion aperture 2, which results in an assured and strong brazing.

In the case where the pipe 1 is provided with outwardly curved tube-insertion guide at the longitudinal outer edges 16 of the tube-insertion aperture 2 as shown in FIG. 22, a dented portion (brazing material gathering portion) is formed between the longitudinal outer edges 16 and the tube 3 inserted in the tube-insertion aperture 2. As a result, the melted brazing materials are gathered in the dented portion, resulting in an assured and strong brazing.

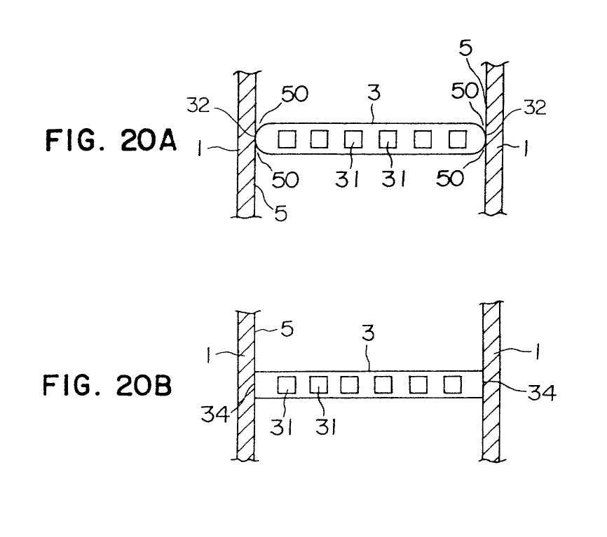

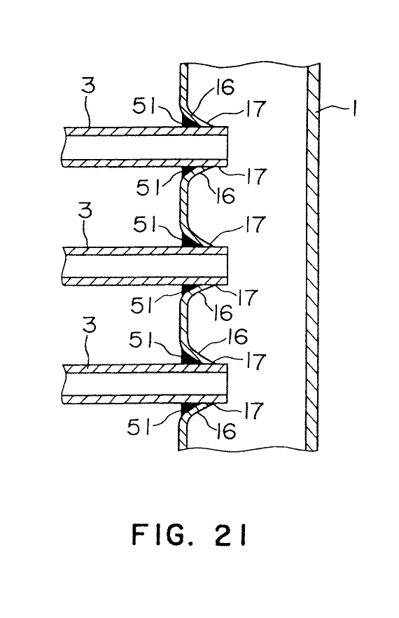

In cases where the tube shown in FIG. 13A, 13C or 14A is used, since the lateral outer surface 32 of the tube 3 is round, a dented portion 50 (brazing material gathering portion) is formed between the lateral outer surface 32 and the inner surface 5 of the pipe-forming member 6 when the tube 3 is inserted in the tube-insertion aperture 2 as shown in FIG. 20A. As a result, the melted brazing materials are gathered in the dented portion 50, resulting in an assured and strong brazing.

In the case where the tube 3 shown in FIG. 14B is used, since the tube-insertion guide portion 34 is flat, no dented portion (brazing material gathering portion) is formed between the tube-insertion guide portion 34 and the inner surface 5 of the pipe-forming member 6 when the tube 3 is inserted in the tube-insertion aperture 2 as shown in FIG. 20B. However, the tube-insertion guide portion 34 and the inner surface 5 of the pipe-forming member 6 contact in a face-to-face manner, resulting in an assured and strong brazing.

(Second Embodiment)

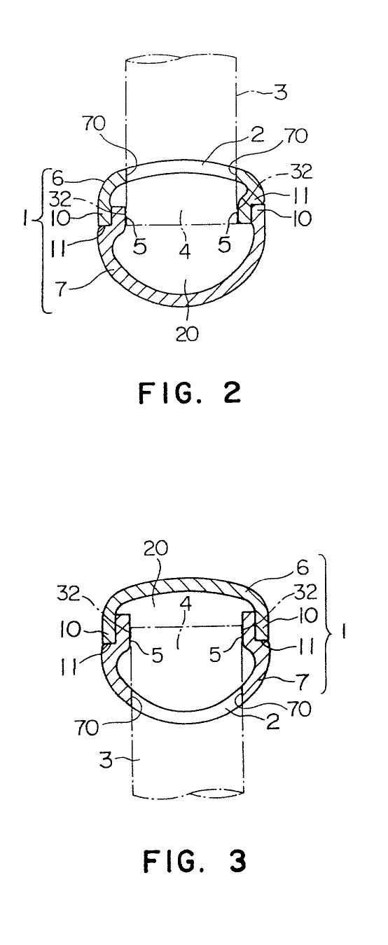

FIG. 2 shows a second embodiment of the present invention.

The pipe 1 is formed by coupling two pipe-forming members 6 and 7. Each pipe-forming member 6 and 7 is provided with an abutting portion 10 and a receiving portion 11. Both the pipe-forming members 6 and 7 are coupled to each other such that the abutting portions 10 are abutted against the receiving portions 11. In the pipe 1 for use in a heat exchanger, the lateral outer sides 32 of the inserting portion 4 of the tube 3 inserted into the pipe-forming member 6 through the tube-insertion aperture 2 is assuredly brazed to the inner surfaces 5 of the pipe 1, and both the pipe-forming members 6 and 7 are brazed each other in a fluid-tight manner.

(Third Embodiment)

FIG. 3 shows a third embodiment of the present invention.

This pipe 1 for use in a heat exchanger is also formed by coupling two pipe-forming members 6 and 7. One of the pipe-forming members 6 is provided with abutting portions 10, and the other of the pipe-forming members 7 is provided with receiving portions 11. Both the pipe-forming members 6 and 7 are coupled each other such that the abutting portions 10 are abutted against the receiving portions 11. In this pipe 1, the lateral outer sides 32 of the inserting portion 4 of the tube 3 inserted into the pipe 1 through the tube-insertion aperture 2 formed in the pipe-forming member 7 is assuredly brazed to the inner surfaces 5 of the pipe 1, and both the pipe-forming members 6 and 7 are brazed to each other in a fluid-tight manner.

(Fourth Embodiment)

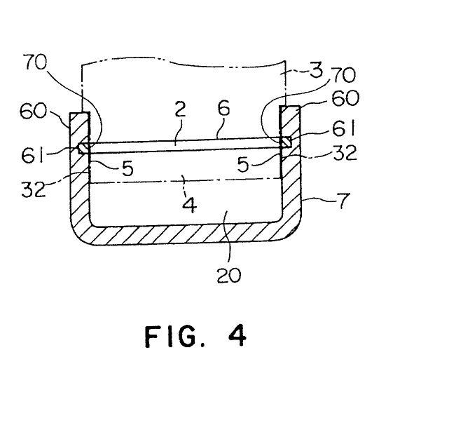

FIG. 4 shows a fourth embodiment of the present invention.

In this embodiment, the pipe 1 is comprised of a channel-shaped pipe-forming member 7 and a plate-shaped pipe-forming member 6. The channel-shaped pipe-forming member 7 has a pair of side walls 60 each having an insertion groove 61, and the plate-shaped pipe-forming member has a plurality of tube-insertion apertures 2. The lateral ends of the plate-shaped pipe-forming member 6 are inserted in the insertion grooves 61 to form a pipe, and the inserting portion 4 of the tube 3 is inserted into the pipe through the tube-insertion aperture 2. In this pipe 1, the lateral outer sides 32 of the inserting portion 4 of the tube 3 is assuredly brazed to the inner surfaces 5 of the pipe 1, and both the pipe-forming members 6 and 7 are brazed to each other in a fluid-tight manner.

(Fifth Embodiment)

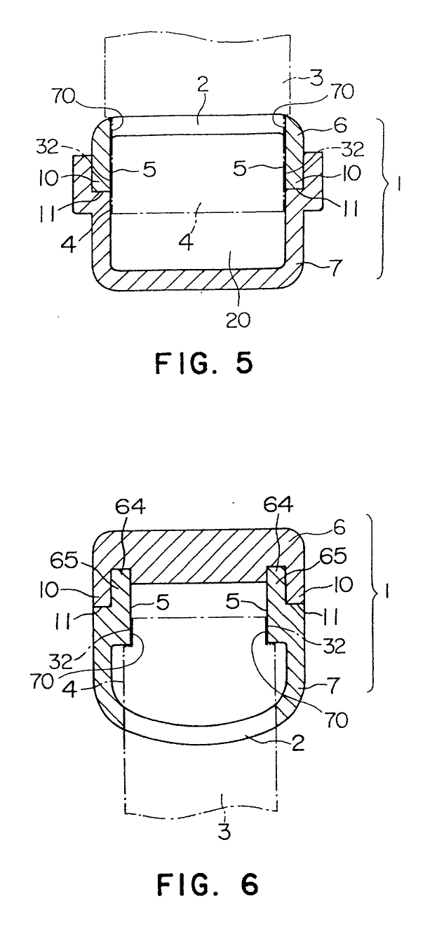

FIG. 5 shows a fifth embodiment of the present invention.

In this embodiment, the pipe 1 is comprised of a generally channel-shaped pipe-forming member 7 having an opening facing upwardly in FIG. 5 and a channel-shaped pipe-forming member 6 having an opening facing downwardly in FIG. 5. The channel-shaped pipe-forming member 7 has a pair of receiving portions 11 at the opening edges, and the channel-shaped pipe-forming member 6 has a pair of abutting portions 10 at the opening edges. The pipe-forming members 6 and 7 are coupled each other such that the abutting portions 10 abuts against the receiving portions 11 to form a pipe 1 for use in a heat exchanger. In this pipe 1, the lateral outer sides 32 of the inserting portion 4 of the tube 3 are assuredly brazed to the inner surfaces 5 of the pipe 1, and both the pipe-forming members 6 and 7 are brazed to each other in a fluid-tight manner.

(Sixth Embodiment)

FIG. 6 shows a sixth embodiment of the present invention.

In this embodiment, the pipe 1 is comprised of a channel-shaped pipe-forming member 7 having an opening facing upwardly in FIG. 6 and a shallow channel-shaped pipe-forming member 6 having a thick bottom wall. The channel-shaped pipe-forming member 7 is provided with L-shaped receiving portions 11. The channel-shaped pipe-forming member 6 is provided with abutting portions 10 at the lateral edges and fitting grooves 64 inside the abutting portions 10. The pipe-forming members 6 and 7 are coupled each other such that the lateral edges 65 of the pipe-forming member 7 are inserted into the fitting grooves 64 and that the abutting portions 10 abuts against the receiving portions 11 to form a pipe 1 for use in a heat exchanger. In this pipe 1, the lateral outer sides 32 of the inserting portion 4 of the tube 3 are assuredly brazed to the inner surfaces 5 of the pipe 1, and both the pipe-forming members 6 and 7 are brazed to each other in a fluid-tight manner.

(Seventh Embodiment)

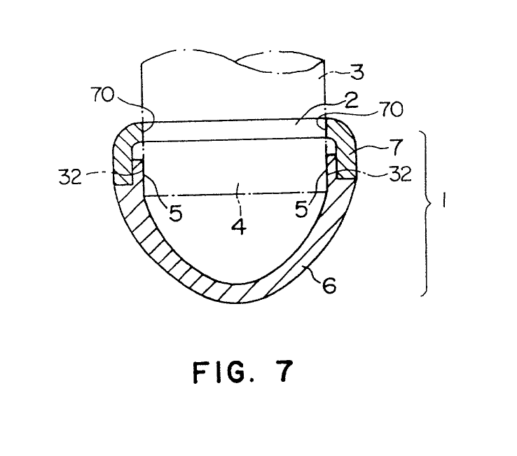

FIG. 7 shows a seventh embodiment of the present invention.

In this embodiment, the pipe 1 is comprised of a pipe-forming member 6 of a generally V-shaped cross-section and a shallow channel-shaped pipe-forming member 7. The pipe-forming members 6 and 7 are coupled each other to form a pipe 1 for use in a heat exchanger. In this pipe 1, the lateral outer sides 32 of the inserting portion 4 of the tube 3 inserted in the tube 1 through the tube-insertion aperture 2 are assuredly brazed to the inner surfaces 5 of the pipe 1, and both the pipe-forming members 6 and 7 are brazed to each other in a fluid-tight manner.

In this embodiment, since the pipe-forming member 6 has a generally V-shaped cross-section, the inserted end of the tube 1 abuts against the inner surface 5 of the pipe-forming member 6 as the inserting portion 4 of the tube 3 is inserted into the tube 1, resulting in an appropriate positioning of the tube 3.

(Eighth Embodiment)

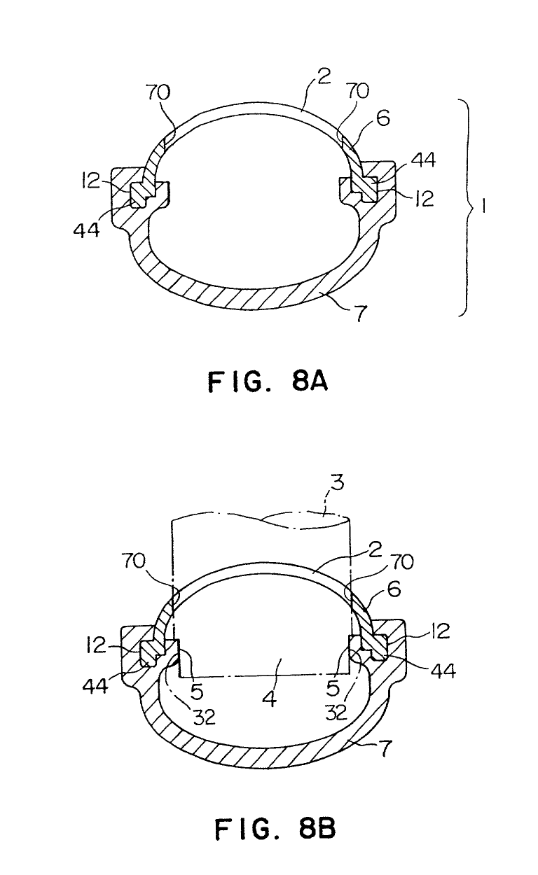

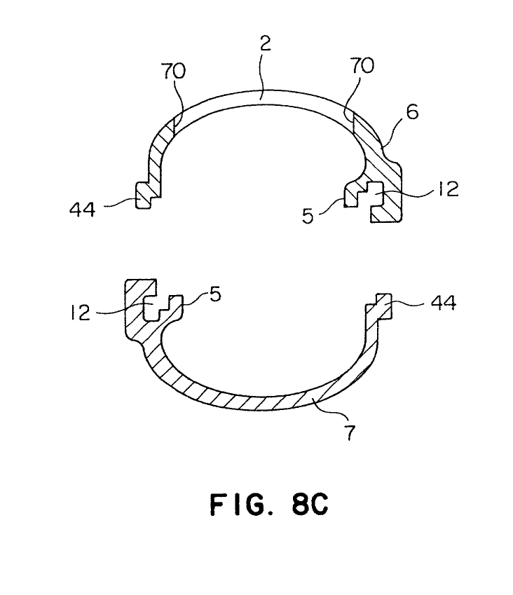

FIGS. 8A and 8B show an eighth embodiment of the present invention.

In this embodiment, the pipe 1 is comprised of a pipe-forming member 7 having a pair of fitting grooves 12 at its longitudinal edges and a pipe-forming member 6 having a pair of inserting portions 44 at its longitudinal edges. The pipe-forming members 6 and 7 are coupled each other to form a pipe 1 for use in a heat exchanger such that the inserting portions 44 are fitted in the fitting grooves 12. In this pipe 1, as shown in FIG. 8B, the lateral outer sides 32 of the inserting portion 4 of the tube 3 inserted in the tube 1 through the tube-insertion aperture 2 are assuredly brazed to the inner surfaces 5 of the pipe 1, and both the pipe-forming members 6 and 7 are brazed to each other in a fluid-tight manner. In this embodiment, the coupling of the pipe-forming members 6 and 7 can be easily performed by inserting the inserting portions 44 into the fitting grooves 12 from the longitudinal end of the fitting groove 12. As shown in FIG. 8B, the tube 3 is inserted in the pipe 1 through the tube-insertion aperture 2 of the pipe-forming member 6, and then heated. As a result, both the pipe-forming members 6 and 7 are brazed to each other in a fluid-tight manner, and the lateral outer sides 32 of the inserting portion 4 of the tube 3 are assuredly brazed to the inner surfaces 5 of the pipe 1.

(Ninth Embodiment)

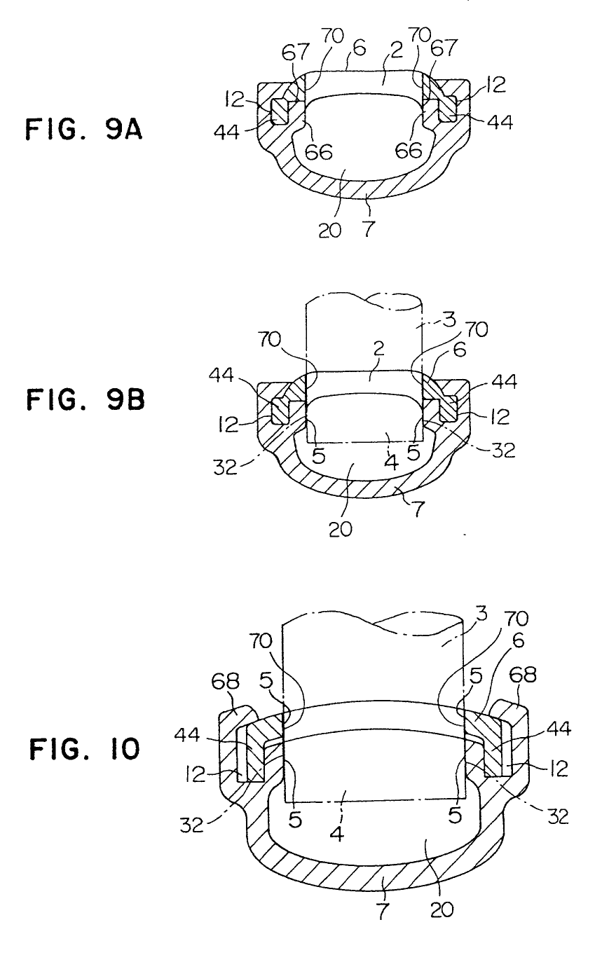

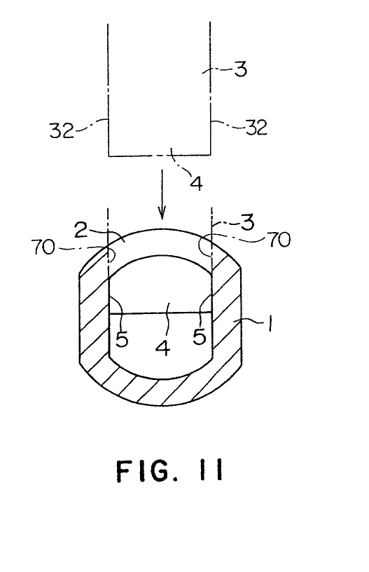

FIGS. 9A and 9B show a ninth embodiment of the present invention.

In this embodiment, the pipe 1 is comprised of a pipe-forming member 7 having a pair of fitting grooves 12 at its longitudinal edges and a pipe-forming member 6 having a pair of inserting portions 44 at its longitudinal edges. Furthermore, the pipe-forming member 7 has a pair of inner abutting portions 66 at its longitudinal edges, and the pipe-forming member 6 has a pair of receiving portions 67 for receiving the inner abutting portions 66. The pipe-forming members 6 and 7 are coupled each other to form a pipe 1 for use in a heat exchanger such that the inserting portions 44 are fitted in the fitting grooves 12 and that the inner abutting portions 66 abut against the receiving portions 67. The tube 3 is inserted in the pipe 1 through the tube-insertion aperture 2 of the pipe-forming member 6, and then heated. As a result, both the pipe-forming members 6 and 7 are brazed to each other in a fluid-tight manner, and the lateral outer sides 32 of the inserting portion 4 of the tube 3 are assuredly brazed to the inner surfaces 5 of both the pipe-forming members 6 and 7.

(Tenth Embodiment)

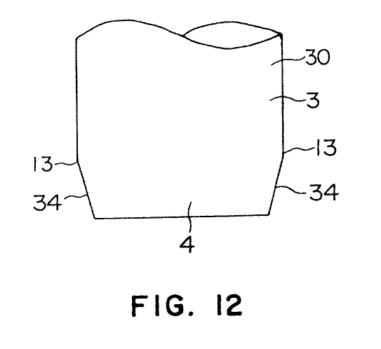

FIG. 10 shows a tenth embodiment of the present invention.

In this embodiment, the pipe 1 is comprised of a pipe-forming member 7 having a pair of fitting grooves 12 at its longitudinal edges and a pipe-forming member 6 having a pair of inserting portions 44 at its longitudinal edges. As shown in FIG. 10, a gap is formed between the inserting portion 44 and the fitting groove 12 when the former is inserted into the latter. In this case, the insertion of the inserting portions 44 into the fitting groove 12 can be easily performed. After the insertion, the upper portions 68 of the outer walls of the pipe-forming member 7 are bent inwardly so as to press the upper sides of the pipe-forming member 6 to thereby tightly couple both the pipe-forming members 6 and 7 to each other. Thereafter, both the pipe-forming members 6 and 7 are brazed to each other in a fluid-tight manner, and the lateral outer sides 32 of the inserting portion 4 of the tube 3 are assuredly brazed to the inner surfaces 5 of both the pipe-forming members 6 and 7.

(Eleventh Embodiment)

FIG. 11 shows an eleventh embodiment of the present invention.

In this embodiment, the pipe 1 for use in a heat exchanger is made of a round pipe having flat sides. The pipe 1 is provided with a plurality of tube-insertion apertures 2. The tube 3 is inserted into the tube-insertion aperture 2, and the lateral outer sides 32 of the inserting portion 4 of the tube 3 are assuredly brazed to the inner surfaces 5 of the pipe 1.

In any one of the above-mentioned second to eleventh embodiments, both side surfaces 70 of the tube-insertion aperture 2 and the outer surface of the tube 3 inserted into the tube-insertion aperture 2 are fluid-tightly brazed. Furthermore, in the above-mentioned embodiments, although members are brazed with each other, they may be secured by any method other than the brazing method.

According to the present invention, the connection structure between a pipe and a tube for use in a heat exchanger includes a pipe having a tube-insertion aperture, and a tube having an insertion portion, wherein the tube is inserted into the pipe through the tube-insertion aperture, and wherein the insertion portion is secured to an inner surface of the pipe. Accordingly, the brazing of the tube to the pipe can be more assuredly performed as compared to the conventional structure in which a tube is brazed only to the peripheral edge of the tube-insertion aperture. Therefore, even if the inner pressure of the pipe increases higher than the conventional high-pressure (for example, the inner pressure increases to several hundreds Kg), no cracks will occur at the brazing portion, and the tube will not detached from the pipe, resulting in no leakage of refrigerant.

In a case where a pair of pipe-forming members are coupled to each other and the inserting portion of the tube is brazed to the inner surface of at least one of the pipe-forming members, since the tube is secured to the inner surface of the pipe and the pipe-forming members are secured each other, the brazing can be assuredly performed, resulting in no leakage of refrigerant.

In a case where pipe-forming members are provided with abutting portions and receiving portions for receiving the abutting portions, the assembling of the pipe-forming members can be easily performed.

In a case where one of the pipe-forming members has a fitting groove and the other has an inserting portion to be inserted in the fitting groove, the coupling of the pipe-forming members can be enhanced.

In a case where members constituting a heat exchanger including pipe-forming members and tubes are brazed to each other, the securing thereof can be enhanced.

In a case where a tube has a tube-insertion regulating portion for regulating a tube-insertion length in the pipe, each insertion length of plural tubes can be adjusted to a certain amount, which in turn results in a smooth flow of refrigerant in the pipe.

This application claims priority to Japanese Patent Application No. H11(1999)-169037 filed on Jun. 15, 1999, the disclosure of which is incorporated by reference in its entirety.

The terms and expressions which have been employed herein are used as terms of description and not of limitation, and there is no intent, in the use of such terms and expressions, of excluding any of the equivalents of the features shown and described or portions thereof, but it is recognized that various modifications are possible within the scope of the invention claimed.

What is claimed is:

1. A connection structure between a pipe and a tube for use in a heat exchanger, comprising:
a pipe having a tube-insertion aperture; and
a tube having an insertion portion,
wherein said tube is inserted into said pipe through said tube-insertion aperture, and
wherein said insertion portion is secured to an inner surface of said pipe.

2. The connection structure as recited in claim 1, wherein said pipe is formed by coupling a pair of pipe-forming members.

3. The connection structure as recited in claim 1, wherein said pipe is formed by rolling a single plate into a round shape in cross-section.

4. The connection structure as recited in claim 1, wherein said pipe is a seamless pipe.

5. The connection structure as recited in claim 2, wherein said insertion portion is secured to an inner surface of at least one of said pipe-forming members, and wherein said pipe-forming members are secured to each other in a fluid-tight manner.

6. The connection structure as recited in claim 2, wherein one of said pipe forming members is provided with an abutting portion and the other of said pipe-forming members is provided with a receiving portion, and wherein said pipe-forming members are coupled each other such that said abutting portion abuts against said receiving portion.

7. The connection structure as recited in claim 2, wherein one of said pipe-forming members is provided with a fitting groove, wherein the other of said pipe-forming members is provided with a fitting portion, and wherein said fitting portion is secured to said fitting groove in a fluid-tight manner with said fitting portion fitted in said fitting groove.

8. The connection structure as recited in claim 2, wherein said pipe-forming members are brazed each other, and wherein said pipe and said tube-insertion portion of said tube are brazed each other.

9. The connection structure as recited in claim 5, wherein said pipe-forming members are brazed each other, and wherein said pipe and said tube-insertion portion of said tube are brazed each other.

10. The connection structure as recited in claim 6, wherein said pipe-forming members are brazed each other, and wherein said pipe and said tube-insertion portion of said tube are brazed each other.

11. The connection structure as recited in claim 7, wherein said pipe-forming members are brazed each other, and wherein said pipe and said tube-insertion portion of said tube are brazed each other.

12. The connection structure as recited in claim 1, wherein said tube is provided with a tube-insertion regulating portion at a side of a longitudinal end portion of said tube for regulating a tube-insertion-length relative to said pipe.

13. The connection structure as recited in claim 2, wherein said tube is provided with a tube-insertion regulating portion at a side of a longitudinal end portion of said tube for regulating a tube-insertion-length relative to said pipe.

14. The connection structure as recited in claim 3, wherein said tube is provided with a tube-insertion regulating portion at a side of a longitudinal end portion of said tube for regulating a tube-insertion-length relative to said pipe.

15. The connection structure as recited in claim 4, wherein said tube is provided with a tube-insertion regulating portion at a side of a longitudinal end portion of said tube for regulating a tube-insertion-length relative to said pipe.

16. The connection structure as recited in claim 5, wherein said tube is provided with a tube-insertion regulating portion at a side of a longitudinal end portion of said tube for regulating a tube-insertion-length relative to said pipe.

17. The connection structure as recited in claim 6, wherein said tube is provided with a tube-insertion regulating portion at a side of a longitudinal end portion of said tube for regulating a tube-insertion-length relative to said pipe.

18. The connection structure as recited in claim 7, wherein said tube is provided with a tube-insertion regulating portion at a side of a longitudinal end portion of said tube for regulating a tube-insertion-length relative to said pipe.
